(19) United States
(12) Patent Application Publication
(10) Pub. No.: US 2005/0175184 A1
(43) Pub. Date: Aug. 11, 2005

(54) Method and apparatus for a per-packet encryption system

(75) Inventors: Douglas M. Grover, Elk Ridge, UT (US); Douglas Steck, Riverton, UT (US); W. Paul Willes, Alpine, UT (US); Thomas R. Rohlfing, Salt Lake City, UT (US); Ronald S. Leahy, Salt Lake City, US (US)

Correspondence Address: Lloyd W. Sadler;Snell & Wilmer, LLP, Suite 1200, 15 West South Temple, Salt Lake City, UT, 84101, US

(73) Assignee: Phonex Broadband Corporation, Midvale, UT (US)

(21) Appl. No.: 10/776,474

(22) Filed: Feb. 11, 2004

(51) Int. Cl. H04L 9/00

(52) U.S. Cl. 380/278

(57) ABSTRACT

A network security system designed to provide per-packet encryption based on an encryption key identifier and an associated encryption key. Packets or groups of packets are encrypted based on information that relates to the packet such as service type, network number, and the like. This encryption criterion is associated with an encryption key and encryption key identifier. When a packet contains the certain criteria, the packet is encrypted using the encryption key. The packet is sent across the network using the encryption key identifier and the encrypted payload. The targeted nodes decrypt the packet using the reverse process.

### BACKGROUND OF THE INVENTION

1. Field of the Invention

This invention relates to electronic communications systems. More specifically, this invention relates to electronic communications systems which encrypt packets.

2. Description of Related Art

A variety of communication systems use methods for encrypting packets as they are sent across a network. Typically, such approaches do not allow for flexible per-packet encryption based on fields in the packets to isolate networks and communications within a network. Although these references may not constitute prior art, for general background material, the reader is directed to the following United States Patents, each of which is hereby incorporated by reference in its entirety for the material contained therein: U.S. Pat. Nos. 6,415,031, 6,253,326, 6,185,680, 6,092,191, 6,052,466, 5,898,784, 5,805,705, and 5,594,869.

### SUMMARY OF THE INVENTION

It is desirable to provide a packet encryption system that can encrypt or not encrypt each packet based on specific elements of the packet's content, thus providing isolation and securing for specific applications, networks, sub-networks, nodes, protocols, etc.

Therefore it is a general object of this invention to provide a packet encryption system that can provide per-packet encryption based on one or more different encryption keys.

It is a further object of an embodiment of this invention to provide a per-packet encryption system based an encryption key identifier within a packet or group of packets.

It is a further object of an embodiment of this invention to provide a per-packet encryption system based on information within the packet or information external to the packet.

It is a further object of an embodiment of this invention to provide a per-packet encryption system based a node address.

It is a further object of an embodiment of this invention to provide a per-packet encryption system based a network address.

It is a further object of an embodiment of this invention to provide a per-packet encryption system that can encrypt packets based on a sub-network address.

It is a further object of an embodiment of this invention to provide a per-packet encryption system that can encrypt packets based on a socket.

It is a further object of an embodiment of this invention to provide a per-packet encryption system that can encrypt packets based upon the protocols within each packet.

It is a further object of an embodiment of this invention to provide a per-packet encryption system based on any field within the Open System Interconnect model.

It is a further object of an embodiment of this invention to provide a per-packet encryption system based any combination of fields within the packet payload.

It is a further object of an embodiment of this invention to provide a packet decryption system that can provide per-packet decryption based on different encryption keys.

It is a further object of an embodiment of this invention to provide a per-packet decryption system based an encryption key identifier within a packet or group of packets.

It is a further object of an embodiment of this invention to provide a per-packet encryption and decryption system using a communication channel on a wireless network, a power line network, a light frequency network, an acoustic network and a wired network.

These and other objects of this invention will be readily apparent to those of ordinary skill in the art upon review of the following drawings, detailed description, and claims. In the present preferred embodiment of this invention, the per-packet encryption system makes use of a novel packet encryption scheme based on an encryption key identifier placed in the packet or within a group of packets.

### BRIEF DESCRIPTION OF DRAWINGS

In order to show the manner that the above recited and other advantages and objects of the invention are obtained, a more particular description of the preferred embodiments of this invention, which are illustrated in the appended drawings, is described as follows. The reader should understand that the drawings depict only present preferred and best mode embodiments of the invention, and are not to be considered as limiting in scope. A brief description of the drawings is as follows:

FIG. 1a is a diagram of the present preferred network for sending packets between network nodes.

FIG. 1b is a diagram of the present preferred encryption packet structure used by this invention.

FIG. 2 is a diagram of another present preferred encryption packet structure used by this invention.

FIG. 3 is a flow diagram of the present preferred encryption key and encryption key identifier exchange process.

FIG. 4 is a flow diagram of the present preferred packet encryption process for a node sending packets on a network.

FIG. 5 is a flow diagram of the present preferred packet decryption process for a node receiving packets on a network.

FIG. 6 is a flow diagram of the present preferred packet encryption process for sending packet groups.

FIG. 7 is a flow diagram of the present preferred packet encryption process for receiving packet groups.

Reference will now be made in detail to the present preferred embodiment of the invention, examples of which are illustrated in the accompanying drawings.

### DETAILED DESCRIPTION

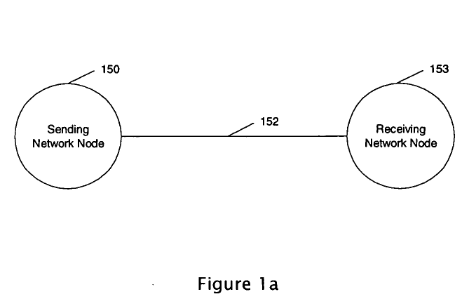

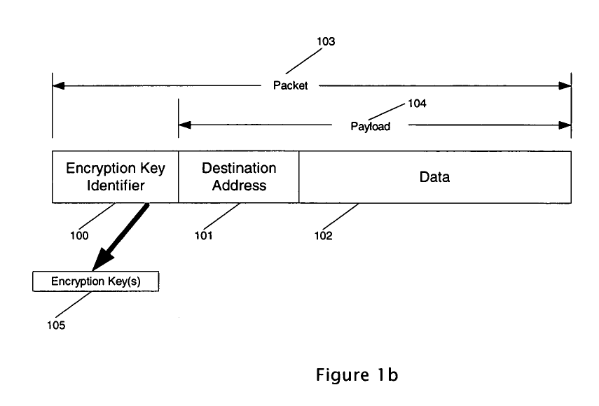

FIG. 1a is a diagram of the present preferred network for sending packets between network nodes. A communication channel 152 is formed by a sending network node 150 and receiving network node 151 which send packets 103 or packet groups 205 between the network nodes.

FIG. 1b is a diagram of the present preferred encryption packet structure used by this invention. Packets 103 are constructed on a sending network node 150 and sent across a communication channel 152 using an encryption key identifier field 100, a destination address field 101, and packet data 102. The payload 104 is defined as anything in the packet other than the encryption key identifier. The destination address field 101 is used to identify a single node or a plurality of nodes on the network. For example, the destination address field 101 can be a broadcast to all nodes on the network or a sub-net address which address specific nodes within the network. The destination address field 101 can also be a network address used to identify a node or nodes on a remote network. The encryption key identifier field 100 is used to identify an encryption key 105 used to encrypt the packet payload 104 or parts of the packet payload 104 such as only encrypting the data 102 portion of the packet. The encryption key identifier field 100 can also be used to indicate that the packet payload 104 is not encrypted. The packet payload 104 gets encrypted using the encryption key 105 pointed to by the encryption key identifier field 100. The whole packet payload 104 can be encrypted and the packet 103 can be sent without addressing on a point-to-point network. When the packet is received in the receiving network node 151 the encryption key identifier field 100 is used to select the associated encryption key 105 and decrypt the packet.

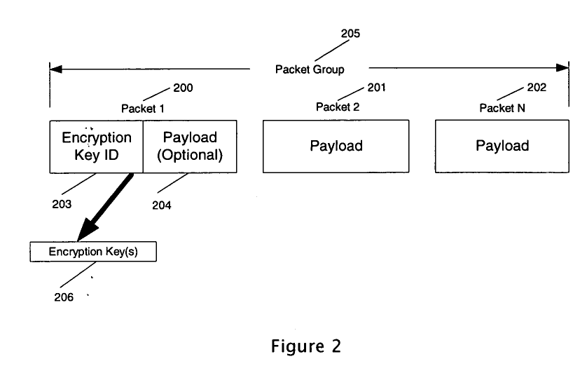

FIG. 2 is a diagram of another preferred encryption packet structure used by this invention. Packets 200-202 are constructed on a sending network node 150 and sent across a communication channel 152 in packet groups 205. One of the packets 200 contains an encryption key identifier 203 used for encryption of the payload fields 204, 201, 202 of all packets in the packet group 205. As shown in FIG. 2, packet one 200 contains the encryption key identifier 203 and optionally a payload field 204. Packets two 201 and subsequent packets 202 are encrypted using the encryption key identifier's 203 encryption key or keys 206. The order in which the packets 200-202 are sent is not critical to decrypting the packet group 205 as long as at least one packet 200-202 in the packet group 205 contains the encryption key identifier 203. The packet group 205 is received by the receiving network node 151. The receiving network node 151 uses the encryption key identifier 203 and encryption key 206 to decrypt the packet group 205.

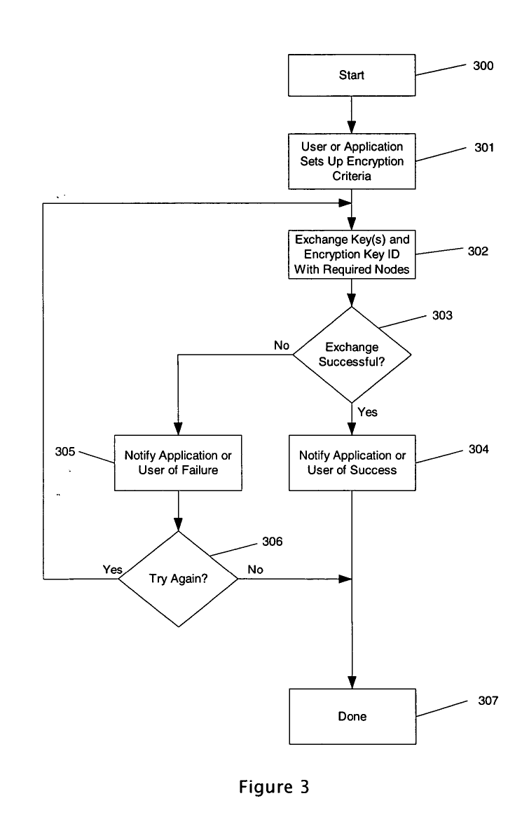

FIG. 3 is a flow diagram of the present preferred encryption key and encryption key identifier exchange process. It should be noted that some encryption algorithms use multiple encryption keys to encrypt data. The process of passing, encrypting and decrypting can be used with either single encryption key algorithms or multiple encryption key algorithms. The present preferred embodiment uses Diffie-Hellman key exchange to exchange encryption keys and encryption key identifiers, but many other alternative key exchange processes will work. The process starts 300 with a user, application, or an external input setting up criteria 301 for the per-packet encryption process. The criteria used can be any field or combination of fields within the packet payload 104, 201, 202, 204 such as without limitation the node address, a network address, sub-network address, a socket, a protocol identifier, a service type, and the like. In addition, it can be a criterion passed down from an application or user which is not contained within the packet payload 104, 201, 202, 204. The encryption key 105, 206 (or keys for multiple key encryption algorithms) is exchanged 302 with the nodes on the network that need the encryption key. If 303 this is successful, the application or user is notified 304 of the successful encryption passing process. The process is complete 307. Otherwise, if test 303 is not successful, the application or user is notified 305 that the encryption passing process failed. If in test 306 the process wants to be tried again, the same key exchange step 302 is repeated. Otherwise, the process is completed 307. Test 306 can be done by a user or alternatively by a process responsible for the system.

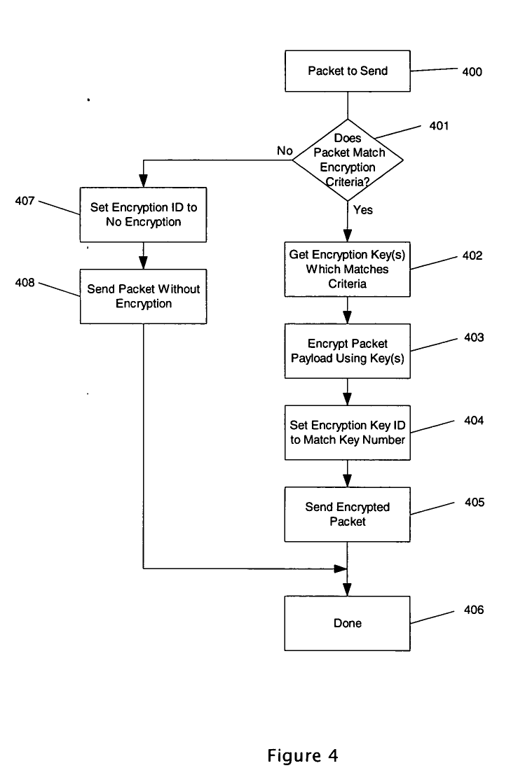

FIG. 4 is a flow diagram of the present preferred packet encryption process for a node sending packets on a network. The process starts 400 when there is a packet 103, to send. The sending network node 150 first checks 401 to see if the packet 103 matches the criteria defined for packet encryption. The criteria for encryption can be that the packet payload 104 uses a particular Internet Protocol Address or Service Type or a combination of both. Alternate criteria include, but may not be limited to source or destination network addresses, sub-network addresses, protocol identifiers, source or destination node addresses, application layer information, or any other fields within the packet. Typically, the user or application sets up a grouping of criteria for which a specific encryption key will be used. A criteria group can be one specific criterion or multiple criteria. There can be multiple groups of criteria with an associated encryption key for each group of criteria. If 401 there is a match for the encryption criteria group, the node gets 402 the encryption key associated with the criteria group. The packet payload 104 is encrypted 403 using the encryption key 105. The encryption key identifier field 100 is set in block 404 with the associated encryption key identifier. The packet 103 is sent 405 from the sending network node 150 across the communication channel 152 along with the encryption key identifier field 100 and the encrypted packet payload 104 or data 102. Otherwise, if the packet does not match any encryption criteria in test 401, the packet encryption identifier field 100 is set 407 to the no encryption value. The packet 103 is sent 408 along with the encryption key identifier 100 for unencrypted packets and the unencrypted packet payload 104. In addition, if only the data 102 portion of the packet 103 is encrypted, the packet can be sent using the destination address field 101 so that the receiving network node 151 does not have to decrypt the payload 104 to determine if the packet 104 is for the receiving network node 151.

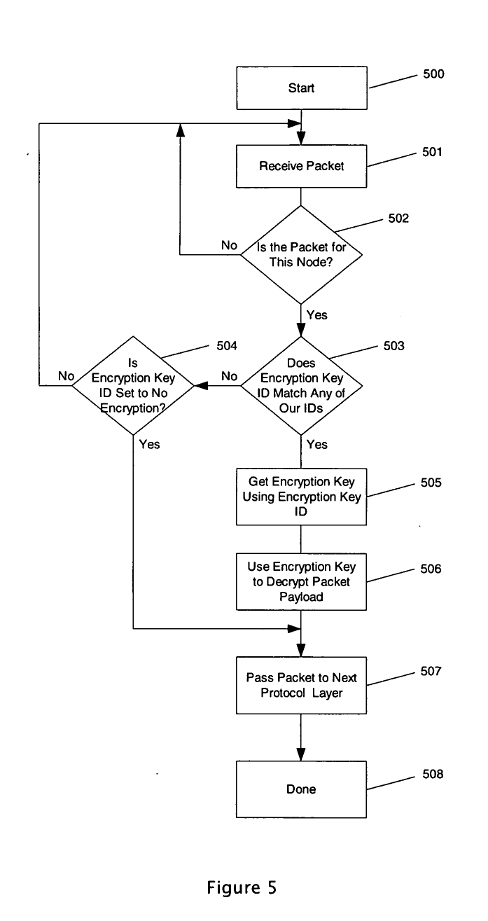

FIG. 5 is a flow diagram of the present preferred packet decryption process for a node receiving packets on a network. The process starts 500 with the receiving 501 of a packet. The receiving network node 151 checks to see if the packet is for the receiving network node 151 in test 502. If the packet is not for the receiving network node 152, the process starts over when another packet is received 501. Otherwise, if test 502 is successful, the encryption key identifier is checked 503 to see if the encryption key identifier matches any of the encryption key identifiers stored in the receiving network node's 151 non-volatile memory. If there is a match in test 503, the node gets 505 the encryption key associated with the encryption key identifier. This encryption key is used to decrypt 506 the packet payload. The unencrypted packet data is passed 507 to the upper protocol layer for processing and the process completes 508. Otherwise, if test 503 is not successful, test 504 checks to see if the encryption key identifier is set to the no encryption value. If not, the process ignores the packet and waits for another packet to be received 501. If the encryption key identifier in test 504 is set to the no encryption value, the packet data is passed 507 to the next protocol layer. The process is complete 508.

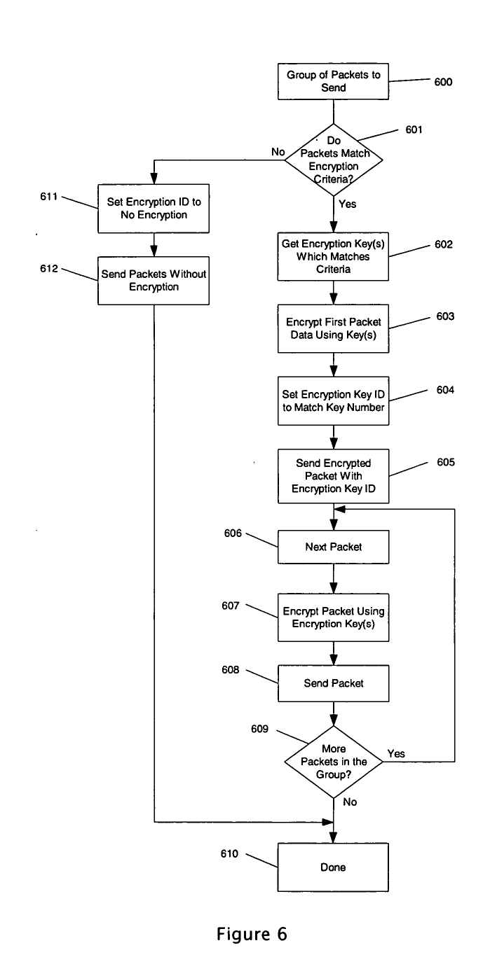

FIG. 6 is a flow diagram of the present preferred packet encryption process for sending packet groups. A packet group 205 is one or more packets 200, 201, 202 that have at least one packet 200 which contains the encryption key identifier 203. The process begins 600 when a sending network node 150 has a packet group 205 to send. If in test 601 the packets 200, 201, 202 do not match the criteria to encrypt the packets 200, 201, 202, the encryption key identifier 203 in the packet 200 is set 611 to no encryption and the packet 200 is sent 612. The process is complete 610. Otherwise, if there is a match in test 601, the encryption key 206 which matches the defined criteria is retrieved 602. The first packet 200 is encrypted 603 using the encryption key 206 if it contains a data field or payload 204 to be encrypted. The first packet 200 can only be the key and have no payload or data to encrypt. Having the first packet 200 contain the encryption key identifier 203 is not a requirement as long as it can be identified from other packets 201, 202 within the packet group 205. The encryption key identifier 203 is set 604 to match the corresponding encryption key. The packet 200 is sent 605 with the encryption key identifier 203. The rest of the packets 201, 202 are sent in the next packet 606. Each of the packets 201, 202 data fields or payloads 201, 202 are encrypted 607 using the encryption key 206 and sent 608. A test is made to determine if 609 there are more packets in the packet group 205. If so the process repeats with the next packet 606. Otherwise, the process completes 610.

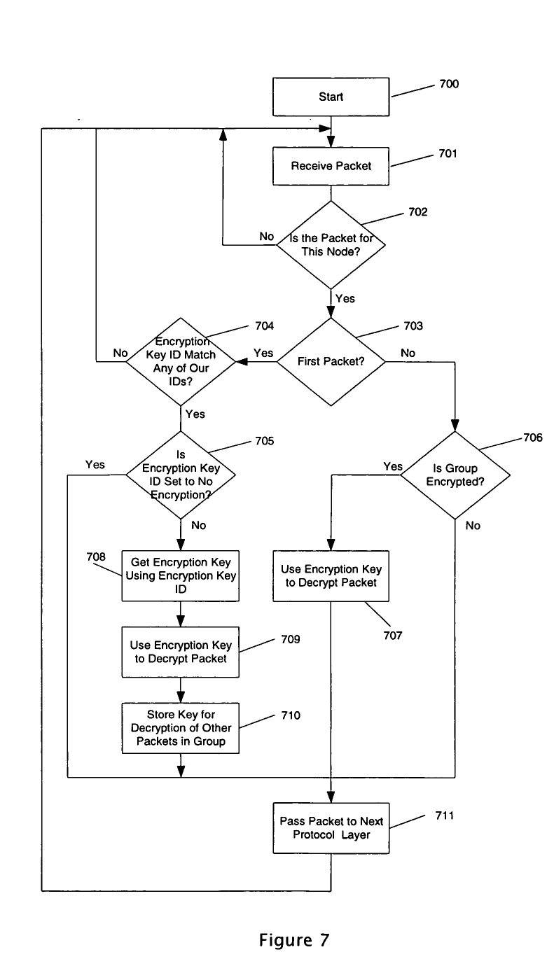

FIG. 7 is a flow diagram of the present preferred packet encryption process for receiving packet groups. The process begins 700 upon the receipt 701 of a packet. If in test 702 the packet is not for the receiving network node 151, the process starts over 701. Otherwise, test 703 checks to see if it is the first packet 200 in the packet group 205. If it is the first packet 200, test 704 checks if the encryption key identifier 203 matches any of the stored encryption key identifiers (including the no encryption key identifier). If the encryption key identifier 203 does not match any of the encryption identifiers from test 704 the process starts again with the receipt of a packet 701. Otherwise, test 705 is performed to see if the encryption identifier 203 is set to no encryption. If so, the packet is passed 711 to the next protocol layer and the process starts all over again with the receipt of a packet 701. If test 705 is no, the node gets 708 the encryption key 206 associated with the encryption key identifier 203. This key is used to decrypt 709 the packet payload 204 if there is one. The encryption key 206 is stored 710 in order to be used to decrypt the rest of the packet group 205. The packet is passed 711 to the next protocol layer and the process repeats 701 with the receipt of a packet. If the received packet is not the first packet 200 in test 703, the received packet is checked 706 based on the stored encryption key identifier which indicates no encryption to see if the packet group 205 is encrypted. If the packet group 205 is not encrypted, the packet is passed 711 to the next protocol layer and the process repeats 701 with the receipt of a packet. Otherwise, the packet is decrypted 707 using the stored encryption key 206 from step 710.

Since these encryption methods are designed to be physical layer independent, they will run over a wide variety of networks, including but are not limited to such types of networks as AC power line, DC power line, light frequency (fiber, light, or the like), Radio Frequency (RF) networks (wireless such 802.11b, infrared, or the like), acoustic networks and wired (coax, twisted pair, or the like).

In addition, these data transportation methods can be implemented using a variety of processes, including but are not limited to computer hardware, microcode, firmware, software, or the like.

The described embodiments of this invention are to be considered in all respects only as illustrative and not as restrictive. Although specific flow diagrams and packet formats are provided, the invention is not limited thereto. The scope of this invention is, therefore, indicated by the claims rather than the foregoing description. All changes, which come within the meaning and range of equivalency of the claims, are to be embraced within their scope.

1. A system for encrypting packets on a network comprising:
A. a plurality of network nodes;
B. a communication channel between said plurality of network nodes;
C. one or more packets sent between said plurality of network nodes over said communication channel;
D. wherein said one or more packets contain an encryption key identifier and a payload;
E. one or more encryption keys stored on one or more of said plurality of network nodes; and
F. a system for encrypting said payload based on said encryption key identifier and said one or more encryption keys:

2. A system for encrypting packets on a network as recited in claim 1, wherein said payload is only partially encrypted.

3. A system for encrypting packets on a network as recited in claim 1, wherein said one or more packets contains a destination address.

4. A system for encrypting packets on a network as recited in claim 1, wherein said encryption key identifier contains a value indicating “no encryption”.

5. A system for encrypting packets on a network as recited in claim 4, wherein information external to the said payload is used to select said encryption key identifier.

6. A system for encrypting packets on a network as recited in claim 1, wherein said payload further comprises one or more fields that are used to select said encryption key identifier.

7. A system for encrypting packets on a network as recited in claim 6, wherein said one or more fields are selected from the group consisting of a socket, a protocol identifier, a node address, a network address, a sub-network address, a service type, and a packet identifier.

8. A system for encrypting packets on a network as recited in claim 6, wherein said one or more fields are selected from the group consisting of the application layer, the presentation layer, the session layer, the transport layer, the network layer, the data link layer, and the physical layer.

9. A system for encrypting packets on a network as recited in claim 1, wherein said communication channel is a network selected from the group consisting of a wireless network, a light frequency network, a power line network, an acoustic network and a wired network.

10. A system for decrypting packets on a network comprising:
A. a plurality of network nodes;
B. a communication channel between said plurality of network nodes;
C. one or more packets sent between said plurality of network nodes over said communication channel;
D. wherein said one or more packets further comprises an encryption key identifier and a payload;
E. one or more encryption keys stored on one or more of said plurality of network nodes; and
F. a system for decrypting said payload based on said encryption key identifier and said one or more encryption keys.

11. A system for decrypting packets on a network as recited in claim 10, wherein said payload is only partially decrypted.

12. A system for decrypting packets on a network as recited in claim 10, wherein said one or more packets further comprises a destination address.

13. A system for decrypting packets on a network as recited in claim 10, wherein said communication channel is a network selected from the group consisting of, a wireless network, a light frequency network, a power line network, an acoustic network and a wired network.

14. A system for encrypting packets on a network comprising:
A. a plurality of network nodes;
B. a communication channel between said plurality of network nodes;
C. one or more packets forming a packet group which are sent on said communication channel between said plurality of network nodes;
D. said packet group further comprising an encryption key identifier and a payload;
E. one or more encryption keys for occurrences of said encryption key identifier; and
F. a system for encrypting said payload based on said encryption key identifier and said one or more encryption keys.

15. A system for encrypting packets on a network as recited in claim 14, wherein said payload is only partially encrypted.

16. A system for encrypting packets on a network as recited in claim 14, wherein said one or more packets further comprises a destination address.

17. A system for encrypting packets on a network as recited in claim 14, wherein said encryption key identifier further comprises a value indicating “no encryption”.

18. A system for encrypting packets on a network as recited in claim 17, wherein information external to the packet payload is used to select said encryption key identifier.

19. A system for encrypting packets on a network as recited in claim 14, wherein said payload further comprises one or more fields that are used to select said encryption key identifier.

20. A system for encrypting packets on a network as recited in claim 19, wherein said field is selected from the group consisting of a socket, a protocol identifier, a node address, a network address, a sub-network address, a service type, and a packet identifier.

21. A system for encrypting packets on a network as recited in claim 19, wherein said field is selected from the group consisting of the application layer, the presentation layer, the session layer, the transport layer, the network layer, the data link layer, and the physical layer.

22. A system for encrypting packets on a network as recited in claim 14, wherein said communication channel is a network selected from the group consisting of, a wireless network, a light frequency network, a power line network, an acoustic network and a wired network.

23. A system for decrypting packets on a network comprising:
A. a plurality of network nodes;
B. a communication channel between said plurality of network nodes;
C. one or more packets forming a packet group which are sent on said communication channel between said plurality of network nodes;
D. said packet group further comprising an encryption key identifier and a payload;
E. one or more encryption keys; and
F. a system for decrypting said payload based on said encryption key identifier and said one or more encryption keys.

24. A system for decrypting packets on a network as recited in claim 23, wherein said payload is only partially decrypted.

25. A system for decrypting packets on a network as recited in claim 23, wherein said one or more packets further comprising a destination address.

26. A system for encrypting packets on a network as recited in claim 23, wherein communication channel is a network selected from the group consisting of, a wireless network, a light frequency network, a power line network, an acoustic network and a wired network.

27. A method for encrypting packets on a network comprising:
A. selecting an encryption key and an associated encryption key identifier;
B. encrypting data to form a payload using said encryption key;
C. building a packet comprising said payload and said encryption key identifier; and
D. sending said packet from a sending network node across a communication channel.

28. A method for encrypting packets on a network as recited in claim 27, wherein said packet is build with a payload that is partially encrypted.

29. A method for encrypting packets on a network as recited in claim 27, wherein said packet is built further comprising a destination address.

30. A method for encrypting packets on a network as recited in claim 27, wherein said packet is built with an encryption key identifier which indicates no encryption.

31. A method for encrypting packets on a network as recited in claim 30, wherein selection of said encryption key identifier is based on information external to said payload.

32. A method for encrypting packets on a network as recited in claim 27, wherein selection of said encryption key identifier is based on information within said payload.

33. A method for encrypting packets on a network as recited in claim 32, wherein selection of said encryption key identifier is based on fields within said payload selected from the group consisting of a socket, a protocol identifier, a node address, a network address, a sub-network address, a service type, and a packet identifier.

34. A method for encrypting packets on a network as recited in claim 27, wherein selection of said encryption key identifier is based on protocol layers within said payload selected from the group consisting of the application layer, the presentation layer, the session layer, the transport layer, the network layer, the data link layer, and the physical layer.

35. A method for encrypting packets on a network as recited in claim 27, wherein said packet is sent on communication channel selected from the group consisting of a wireless network, a light frequency network, a power line network, an acoustic network and a wired network.

36. A method for decrypting packets on a network comprising:
A. receiving a packet on a communication channel wherein said packet further comprises an encryption key identifier and a payload; and
B. decrypting said payload by using an encryption key which is indicated by said encryption key identifier.

37. A method for decrypting packets on a network as recited in claim 36, wherein only part of said payload is decrypted.

38. A method for decrypting packets on a network as recited in claim 36, wherein said packet further comprises a destination address.

39. A method for decrypting packets on a network as recited in claim 36, wherein said packet is received on a communication channel selected from the group consisting of a wireless network, a light frequency network, a power line network, an acoustic network and a wired network.

40. A method for encrypting packets on a network comprising:
A. selecting an encryption key and an associated encryption key identifier;
B. encrypting data with said encryption key which forms one or more payloads;
C. building one or more packets which form a packet group from said one or more payloads wherein a packet from said packet group further comprises an encryption key identifier which identifies said encryption key; and
D. sending said packet group from a sending network node across a communication channel.

41. A method for encrypting packets on a network as recited in claim 40, wherein said one or more payloads are partially encrypted.

42. A method for encrypting packets on a network as recited in claim 40, wherein said one or more packets are built with a destination address.

43. A method for encrypting packets on a network as recited in claim 40, wherein said encryption key identifier indicates no encryption.

44. A method for encrypting packets on a network as recited in claim 43, wherein selection of said encryption key identifier is based on information external to said payload.

45. A method for encrypting packets on a network as recited in claim 40, wherein selection of said encryption key identifier is based on information within said payload.

46. A method for encrypting packets on a network as recited in claim 45, wherein selection of said encryption key identifier is based on fields within said payload selected from the group consisting of a socket, a protocol identifier, a node address, a network address, a sub-network address, a service type, and a packet identifier.

47. A method for encrypting packets on a network as recited in claim 40, wherein selection of said encryption key identifier is based on protocol layers within said payload selected from the group consisting of the application layer, the presentation layer, the session layer, the transport layer, the network layer, the data link layer, and the physical layer.

48. A method for encrypting packets on a network as recited in claim 40, wherein said packet group is sent on a communication channel selected from the group consisting of a wireless network, a light frequency network, an acoustic network, a power line network, and a wired network.

49. A method for decrypting packets on a network comprising:
A. receiving one or more packets which form a packet group on a communication channel wherein said packet group further comprises an encryption key identifier and one or more payloads; and p1 B. decrypting said one or more payloads using an encryption key which is indicated by said encryption key identifier.

50. A method for decrypting packets on a network as recited in claim 49, wherein only part of said one or more payloads is decrypted.

51. A method for decrypting packets on a network as recited in claim 49, wherein said one or more packets further comprises a destination address.

52. A method for decrypting packets on a network as recited in claim 49, wherein said packet is received on communication channel selected from the group consisting of a wireless network, a light frequency network, a power line network, an acoustic network and a wired network.
